(19) United States
(12) Patent Application Publication
(10) Pub. No.: US 2025/0042481 A1
(43) Pub. Date: Feb. 6, 2025

(54) SIDE ACCESSIBLE TRUCK BED

(71) Applicant: Terrence Eugene Smith, SR., Atlanta, GA (US)

(72) Inventor: Terrence Eugene Smith, SR., Atlanta, GA (US)

(21) Appl. No.: 18/365,492

(22) Filed: Aug. 4, 2023

(51) Int. Cl. B62D 33/023; B60J 7/16; B60J 7/19; B60R 13/10; B62D 33/08; B62D 43/10

(52) U.S. Cl. CPC B62D 33/023; B60J 7/1621; B60J 7/198; B60R 13/105; B62D 33/08; B62D 43/10; B60R 3/00; B60R 19/023

(57) ABSTRACT

A vehicle cargo bed has a cargo floor, opposing sidewalls, and a bed lid connected to the cargo bed. The cargo bed is used for transporting objects. The bed lid moves between an open position and a closed position on hinges near a passenger compartment. The floor includes a spare tire cavity. Each sidewall has an interior surface and an exterior surface defining a side of the cargo bed from the passenger compartment to an opposite end of the bed. The sidewalls extend up from the periphery of the floor and each has an upper surface that descends from the passenger compartment and from the opposite end of the cargo bed to form a horizontal surface in between. The bed lid has sidewalls that conform to the bed sidewalls.

### BACKGROUND OF THE INVENTION

The present invention relates to a pickup truck bed and, more particularly, to a side-accessible bed.

Current commercially available pickup truck beds are only accessible from the rear. They are not accessible on all sides.

All companies that construct pickup truck beds have their own parts that can be interchanged or swapped to fit their own make and models as auto manufactures do.

As can be seen, there is a need for a pickup truck bed accessible on all sides.

The present invention provides a pickup truck bed accessible on each side in addition to the rear of the bed. This accessibility is provided with three tail gates.

### SUMMARY OF THE INVENTION

In one aspect of the present invention, a cargo bed of a vehicle for transporting objects comprises a cargo floor, having a periphery, forming a spare tire cavity; opposing sidewalls extending upwardly from the periphery of the cargo floor, each of the opposing sidewalls having an interior surface and an exterior surface defining a side of the cargo bed which extends from a passenger compartment to an opposite end of the cargo bed, each sidewall having an upper surface that descends from the passenger compartment and from the opposite end of the cargo bed to form a horizontal surface therebetween; and a bed lid hingedly joined to the cargo bed abutting the passenger compartment, the bed lid having lid sidewalls conforming to the opposing sidewalls; wherein the bed lid is pivotable between an open position and a closed position.

These and other features, aspects and advantages of the present invention will become better understood with reference to the following drawings, description, and claims.

### BRIEF DESCRIPTION OF THE DRAWINGS

FIG. 1 is a perspective view of a pickup truck bed according to an embodiment of the present invention;

FIG. 2 is a side view thereof;

FIG. 3 is a side view thereof, showing the lid in motion;

FIG. 4 is a detailed perspective view showing the lid in motion; and

FIG. 5 is a detailed perspective view thereof, shown with a bed extender according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a vehicle bed abutting a passenger compartment, having lowered sides and an extendible rear to enhance access to the bed. The vehicle bed may be used for transporting objects.

The truck bed may be accessed from the rear and both sides, improving accessibility to larger loads. The left-side and right-side bed walls may be formed with curved or angled clearance to accommodate a wheel well.

The opposing sidewalls may each be formed as a single piece or the sides, base, and rear of the bed may be formed as a single piece.

In some embodiments, a trunk lid may be operated by an electrical device. In other embodiments, the trunk lid may be operated manually.

In some embodiments, truck bed extenders on at least one end or side may allow the truck to carry a larger load.

The truck bed is not particularly limited and may be any suitable length, such as between about 5 feet and about 10 feet. For example, the bed may be a short bed having a length of about 5 feet 8 inches; a standard bed having a length of about 6 feet 5 inches; or a long bed having a length of about 8 feet.

A person may use the invention to load or unload a pickup truck bed from any side, not only from the rear.

The inventive bed may be made by constructing left-side and right-side tailgates comparable to the rear tailgate. Existing pickup truck beds may be modified by installing left and right-side tailgates.

The materials of manufacture are not particularly limited. For example, the truck side panels, hinges, and bushings may be made from stainless steel. Cables may be made from nylon, for example.

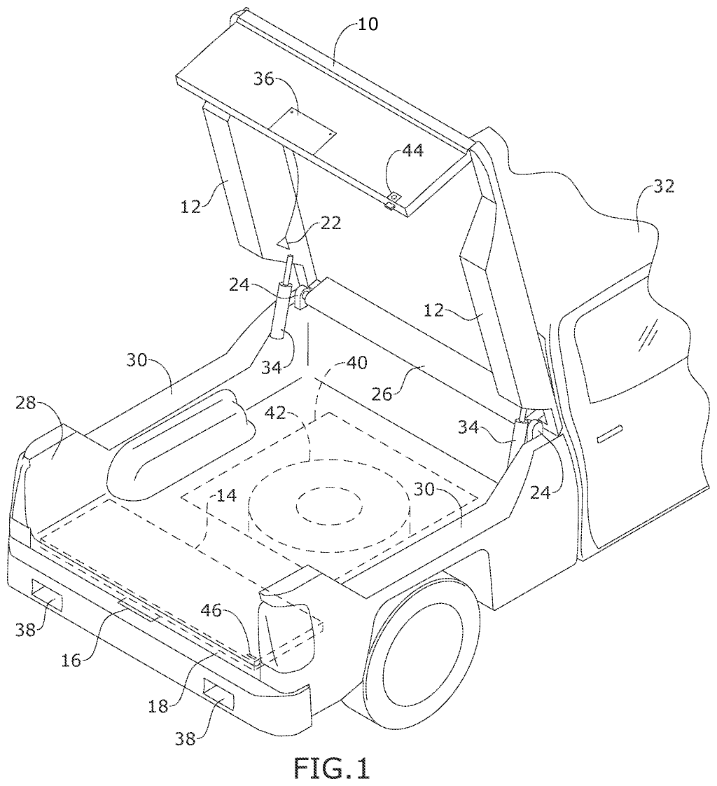

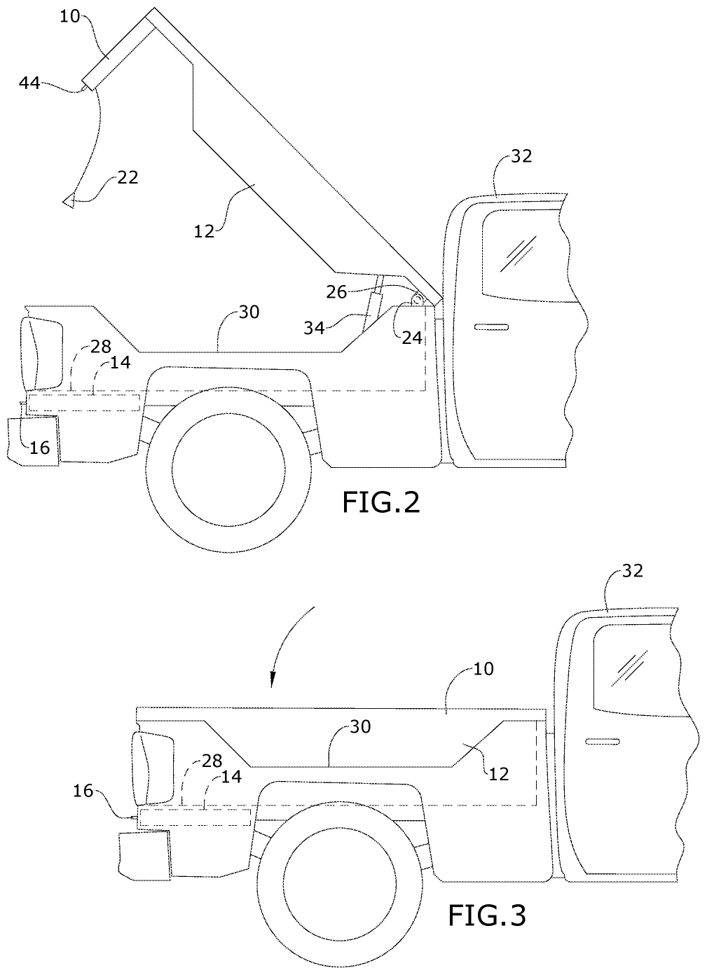

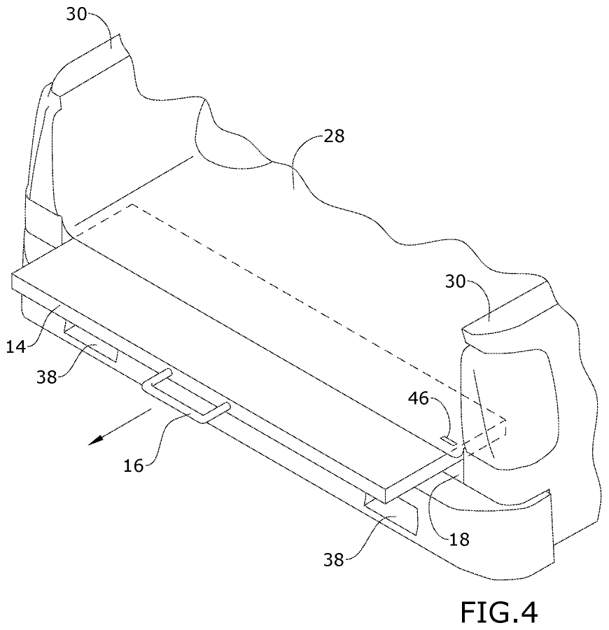

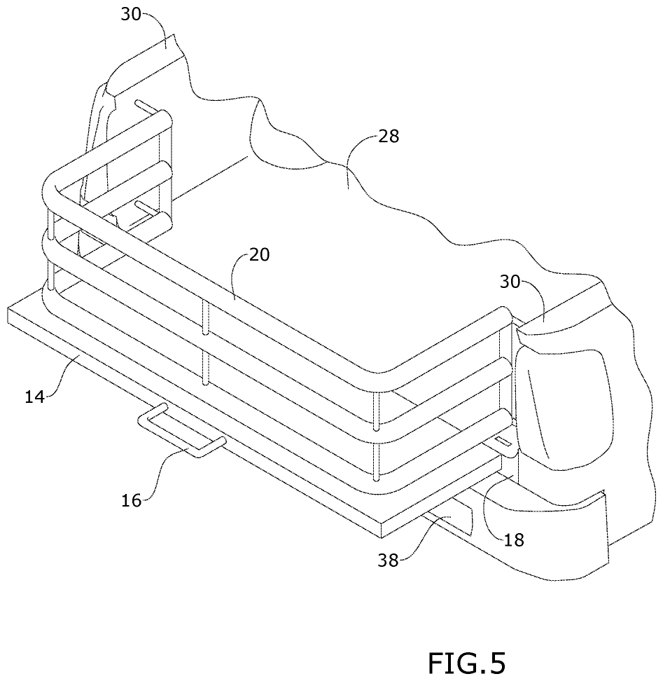

Referring to FIGS. 1 through 5, a truck 32 is shown having a cargo bed 28 with opposing sidewalls rising from the periphery of a cargo floor, each sidewall having a side cutout 30 formed in its upper surface. The bed 28 has a rear bumper with bumper step slats 38 and a spare tire cavity 18 containing a spare tire 42 covered with a spare tire storage cover 40 movably mounted thereon. The side cutouts 30 descend from the ends of each sidewall to form a horizontal surface. The horizontal surface is shown joined to the front and rear portions of the bed sides by angled surfaces. The side cutouts 30 provide easy access to the contents of the truck bed 28 from the exterior at the sides. A bed lid or trunk lid 10 with trunk lid sidewalls 12 that conform to the side cutouts 30 is hingedly coupled to the truck bed 28 with hinges 24, rotating about a lid rod 26, and supported by struts 34. The trunk lid 10 is pivotable between an open position and a closed position. The trunk lid 10 has a rear panel with a license plate mount 36. The rear panel rests snugly against an opposite end of the bed from the passenger compartment. The trunk lid 10 may be lowered using a lid handle 22 and has a latch 44 engageable to a latch receiver 46 at an edge of the truck bed 28. FIG. 4 illustrates a recessed bed extension 14 or cargo slide unit that slidably extends from the rear of the truck bed 28 utilizing a tailgate handle 16. The bed extension 14 may be used with a U-shaped tailgate extender 20 mounted to an interior surface of the sidewalls, as seen in FIG. 5.

It should be understood, of course, that the foregoing relates to exemplary embodiments of the invention and that modifications may be made without departing from the spirit and scope of the invention as set forth in the following claims.

What is claimed is:

1. A cargo bed of a vehicle for transporting objects, comprising:
a cargo floor, having a periphery, forming a spare tire cavity;
opposing sidewalls extending upwardly from the periphery of the cargo floor, each of the opposing sidewalls having an interior surface and an exterior surface defining a side of the cargo bed which extends from a passenger compartment to an opposite end of the cargo bed, each sidewall having an upper surface that descends from the passenger compartment and from the opposite end of the cargo bed to form a horizontal surface therebetween; and
a bed lid hingedly joined to the cargo bed abutting the passenger compartment, the bed lid having lid sidewalls conforming to the opposing sidewalls;
wherein the bed lid is pivotable between an open position and a closed position.

2. The cargo bed of claim 1, wherein the bed lid further comprises a rear panel with a license plate mount.

3. The cargo bed of claim 1, further comprising a rear bumper with bumper step slats.

4. The cargo bed of claim 1, further comprising a storage cover movably mounted over the spare tire cavity.

5. The cargo bed of claim 1, wherein the bed lid further comprises a lid handle.

6. The cargo bed of claim 1, wherein the bed lid further comprises a latch operative to reversibly engage with a latch receiver formed in the cargo floor.

7. The cargo bed of claim 1, further comprising an extension panel slidably mounted within a rear of the cargo floor.

8. The cargo bed of claim 7, wherein the extension panel further comprises a handle.

9. The cargo bed of claim 7, further comprising a tailgate extender removably mountable to the opposing sidewalls.
